(19) United States
(12) Patent Application Publication
(10) Pub. No.: US 2017/0064656 A1
(43) Pub. Date: Mar. 2, 2017

(54) SINGLE RECEIVE LONG TERM EVOLUTION MOBILITY ENHANCEMENTS

(71) Applicant: QUALCOMM Incorporated, San Diego, CA (US)

(72) Inventors: Hobin KIM, San Diego, CA (US); Raghu Narayan CHALLA, San Diego, CA (US); Amir AMINZADEH GOHARI, Sunnyvale, CA (US); Joshua Tennyson MACDONALD, Superior, CO (US)

(21) Appl. No.: 15/232,449

(22) Filed: Aug. 9, 2016

Related U.S. Application Data
(60) Provisional application No. 62/210,417, filed on Aug. 26, 2015.

(51) Int. Cl. H04W 56/00; H04B 17/318; H04W 24/02; H04W 8/02

(52) U.S. Cl. CPC H04W 56/0005; H04W 8/02; H04B 17/318; H04W 24/02

(57) ABSTRACT

Aspects of the present disclosure provide apparatus and techniques to enhance mobility of single receive (RX) devices. An exemplary method generally includes searching for synchronization signals transmitted by one or more cells while performing one or more mobility procedures and taking one or more actions to enhance detection of synchronization signals, wherein the one or more actions taken depend, at least in part, on a type of mobility procedure performed.

### CLAIM OF PRIORITY UNDER 35 U.S.C. §119

This application claims benefit of U.S. Provisional Patent Application Ser. No. 62/210,417, filed Aug. 26, 2015, which is herein incorporated by reference in its entirety

### FIELD OF THE DISCLOSURE

Certain aspects of the present disclosure generally relate to wireless communications and, more particularly, to single receive (RX) long term evolution (LTE) mobility enhancements.

### DESCRIPTION OF RELATED ART

Wireless communication systems are widely deployed to provide various types of communication content such as voice, data, and so on. These systems may be multiple-access systems capable of supporting communication with multiple users by sharing the available system resources (e.g., bandwidth and transmit power). Examples of such multiple-access systems include code division multiple access (CDMA) systems, time division multiple access (TDMA) systems, frequency division multiple access (FDMA) systems, 3rd Generation Partnership Project (3GPP) Long Term Evolution (LTE)/LTE-Advanced systems and orthogonal frequency division multiple access (OFDMA) systems.

Generally, a wireless multiple-access communication system can simultaneously support communication for multiple wireless terminals. Each terminal communicates with one or more base stations via transmissions on the forward and reverse links. The forward link (or downlink) refers to the communication link from the base stations to the terminals, and the reverse link (or uplink) refers to the communication link from the terminals to the base stations. This communication link may be established via a single-input single-output, multiple-input single-output or a multiple-input multiple-output (MIMO) system.

A wireless communication network may include a number of base stations that can support communication for a number of wireless devices. Wireless devices may include user equipments (UEs). Some examples of UEs may include cellular phones, smart phones, personal digital assistants (PDAs), wireless modems, handheld devices, tablets, laptop computers, netbooks, smartbooks, ultrabooks, etc. Some UEs may be considered machine-type communication (MTC) UEs, which may include remote devices, such as sensors, meters, location tags, etc., that may communicate with a base station, another remote device, or some other entity. Machine type communications (MTC) may refer to communication involving at least one remote device on at least one end of the communication and may include forms of data communication which involve one or more entities that do not necessarily need human interaction. MTC UEs may include UEs that are capable of MTC communications with MTC servers and/or other MTC devices through Public Land Mobile Networks (PLMN), for example. Some UEs may be considered “wearables”. Wearables may include wireless devices that may be worn by the user. Wearables may have power and area constraints. Certain UEs, such as MTC UEs and wearables may have only a single RX chain.

To enhance coverage of certain devices, such as MTC devices with infrequent communications and wearables with limited power and area, techniques for link budget enhancements are desired.

### SUMMARY

The systems, methods, and devices of the disclosure each have several aspects, no single one of which is solely responsible for its desirable attributes. Without limiting the scope of this disclosure as expressed by the claims which follow, some features will now be discussed briefly. After considering this discussion, and particularly after reading the section entitled “Detailed Description” one will understand how the features of this disclosure provide advantages that include improved communications in a wireless network.

Certain aspects of the present disclosure provide techniques and apparatus for enhancing mobility of single receiver (RX) devices.

Certain aspects of the present disclosure provide a method for wireless communications by a user equipment (UE) having a single receive antenna or receive chain. The method generally includes searching for synchronization signals transmitted by one or more cells while performing one or more mobility procedures and taking one or more actions to enhance detection of synchronization signals, wherein the one or more actions taken depend, at least in part, on a type of mobility procedure performed.

Certain aspects of the present disclosure provide an apparatus for wireless communications by a user equipment (UE) having a single receive antenna. The apparatus generally includes means for searching for synchronization signals transmitted by one or more cells while performing one or more mobility procedures and means for taking one or more actions to enhance detection of synchronization signals, wherein the one or more actions taken depend, at least in part, on a type of mobility procedure performed.

Certain aspects of the present disclosure provide an apparatus for wireless communications by a user equipment (UE) having a single receive antenna. The apparatus generally includes at least one processor configured to search for synchronization signals transmitted by one or more cells while performing one or more mobility procedures and take one or more actions to enhance detection of synchronization signals, wherein the one or more actions taken depend, at least in part, on a type of mobility procedure performed. The apparatus also generally includes a memory coupled with the at least one processor.

Certain aspects of the present disclosure provide a non-transitory computer-readable medium for wireless communications by a user equipment (UE) having a single receive antenna. The non-transitory computer-readable medium generally includes instructions for searching for synchronization signals transmitted by one or more cells while performing one or more mobility procedures and taking one or more actions to enhance detection of synchronization signals, wherein the one or more actions taken depend, at least in part, on a type of mobility procedure performed.

Numerous other aspects are provided including methods, apparatus, systems, computer program products, and processing systems.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 is a block diagram conceptually illustrating an example of a wireless communication network, in accordance with certain aspects of the present disclosure.

FIG. 2 shows a block diagram conceptually illustrating an example of a base station in communication with a user equipment (UE) in a wireless communications network, in accordance with certain aspects of the present disclosure.

FIG. 3 is a block diagram conceptually illustrating an example of a frame structure in a wireless communications network, in accordance with certain aspects of the present disclosure.

FIG. 4 is a block diagram conceptually illustrating two exemplary subframe formats with the normal cyclic prefix.

FIG. 4A is a diagram illustrating an example of an uplink (UL) frame structure in LTE.

FIG. 5 is a flow diagram of example operations for wireless communications by a UE, in accordance with certain aspects of the present disclosure.

FIG. 6 illustrates a table of various operating states and associated parameters for neighbor cell searching for single receive device, in accordance with certain aspects of the present disclosure.

FIG. 7 illustrates a table of various operating states and associated parameters for neighbor cell measurements for single receive device, in accordance with certain aspects of the present disclosure.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

Aspects of the present disclosure provide techniques that may help enable efficient communication between a base station and certain devices, such as machine type communication (MTC) user equipments (UEs), a wearable device, and/or UE, having a single receiver for long term evolution (LTE). More specifically, aspects of the present disclosure provide techniques for enhancing mobility of single RX devices.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

The techniques described herein may be used for various wireless communication networks such as CDMA, TDMA, FDMA, OFDMA, SC-FDMA and other networks. The terms “network” and “system” are often used interchangeably. A CDMA network may implement a radio technology such as universal terrestrial radio access (UTRA), cdma2000, etc. UTRA includes wideband CDMA (WCDMA), time division synchronous CDMA (TD-SCDMA), and other variants of CDMA. Cdma2000 covers IS-2000, IS-95 and IS-856 standards. A TDMA network may implement a radio technology such as global system for mobile communications (GSM). An OFDMA network may implement a radio technology such as evolved UTRA (E-UTRA), ultra mobile broadband (UMB), IEEE 802.11 (Wi-Fi), IEEE 802.16 (WiMAX), IEEE 802.20, Flash-OFDM®, etc. UTRA and E-UTRA are part of universal mobile telecommunication system (UMTS). 3GPP Long Term Evolution (LTE) and LTE-Advanced (LTE-A), in both frequency division duplex (FDD) and time division duplex (TDD), are new releases of UMTS that use E-UTRA, which employs OFDMA on the downlink and SC-FDMA on the uplink. UTRA, E-UTRA, UMTS, LTE, LTE-A and GSM are described in documents from an organization named “3rd Generation Partnership Project” (3GPP). Cdma2000 and UMB are described in documents from an organization named “3rd Generation Partnership Project 2” (3GPP2). The techniques described herein may be used for the wireless networks and radio technologies mentioned above as well as other wireless networks and radio technologies. For clarity, certain aspects of the techniques are described below for LTE/LTE-Advanced, and LTE/LTE-Advanced terminology is used in much of the description below. LTE and LTE-A are referred to generally as LTE.

### Example Wireless Communications System

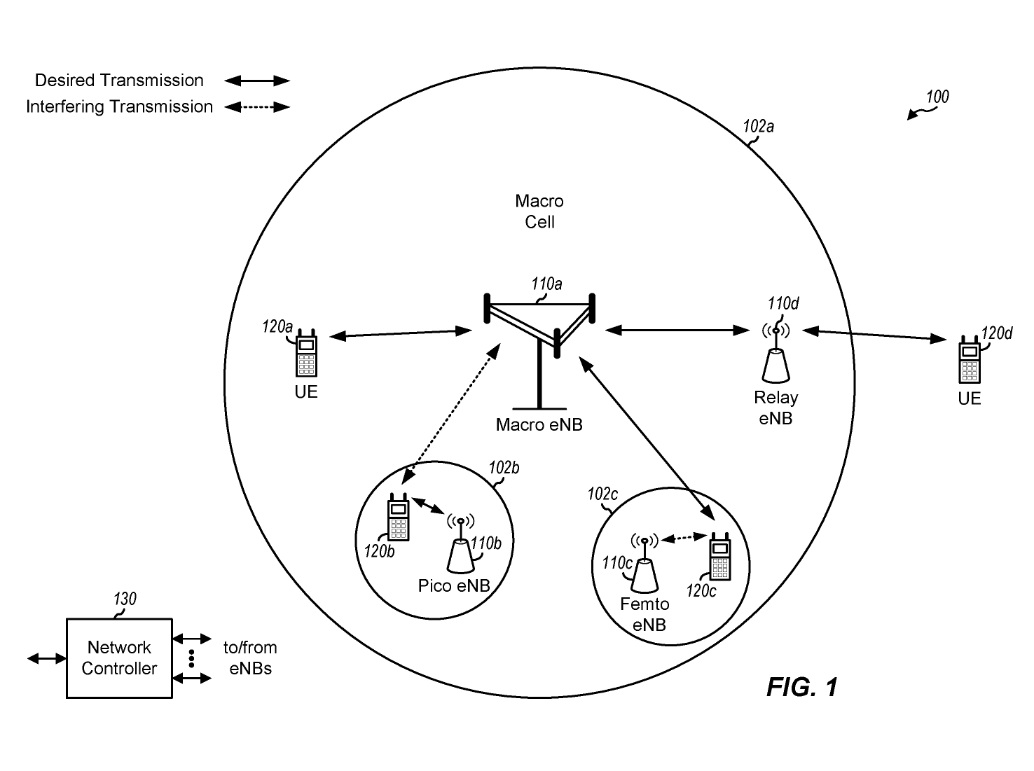

FIG. 1 illustrates an example wireless communication network 100, in which aspects of the present disclosure may be practiced. For example, techniques presented herein may be used to help user equipments (UEs) and base stations (BSs) shown in FIG. 1 communicate. For example, a eNB 110 may receive an indication of UE-Category from a UE 120 and assume a number of number of receivers at the UE 120 based on the UE-Category indicated. The BS 110 may then determine transmit parameters based on the number of receivers at the UE 120. Additionally or alternatively, the UE 120 may employ single receive (RX) long term evolution (LTE) mobility enhancements described herein.

The network 100 may be an LTE network or some other wireless network. Wireless network 100 may include a number of evolved Node Bs (eNBs) 110 and other network entities. An eNB is an entity that communicates with user equipments (UEs) and may also be referred to as a base station, a Node B, an access point, etc. Each eNB may provide communication coverage for a particular geographic area. In 3GPP, the term “cell” can refer to a coverage area of an eNB and/or an eNB subsystem serving this coverage area, depending on the context in which the term is used.

An eNB may provide communication coverage for a macro cell, a pico cell, a femto cell, and/or other types of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). An eNB for a macro cell may be referred to as a macro eNB. An eNB for a pico cell may be referred to as a pico eNB. An eNB for a femto cell may be referred to as a femto eNB or a home eNB (HeNB). In the example shown in FIG. 1, an eNB 110a may be a macro eNB for a macro cell 102a, an eNB 110b may be a pico eNB for a pico cell 102b, and an eNB 110c may be a femto eNB for a femto cell 102c. An eNB may support one or multiple (e.g., three) cells. The terms “eNB”, “base station” and “cell” may be used interchangeably herein.

Wireless network 100 may also include relay stations. A relay station is an entity that can receive a transmission of data from an upstream station (e.g., an eNB or a UE) and send a transmission of the data to a downstream station (e.g., a UE or an eNB). A relay station may also be a UE that can relay transmissions for other UEs. In the example shown in FIG. 1, a relay station 110d may communicate with macro eNB 110a and a UE 120d in order to facilitate communication between eNB 110a and UE 120d. A relay station may also be referred to as a relay eNB, a relay base station, a relay, etc.

Wireless network 100 may be a heterogeneous network that includes eNBs of different types, e.g., macro eNBs, pico eNBs, femto eNBs, relay eNBs, etc. These different types of eNBs may have different transmit power levels, different coverage areas, and different impact on interference in wireless network 100. For example, macro eNBs may have a high transmit power level (e.g., 5 to 40 Watts) whereas pico eNBs, femto eNBs, and relay eNBs may have lower transmit power levels (e.g., 0.1 to 2 Watts).

A network controller 130 may couple to a set of eNBs and may provide coordination and control for these eNBs. Network controller 130 may communicate with the eNBs via a backhaul. The eNBs may also communicate with one another, e.g., directly or indirectly via a wireless or wireline backhaul. UEs 120 (e.g., 120a, 120b, 120c, 120d) may be dispersed throughout wireless network 100, and each UE may be stationary or mobile. A UE may also be referred to as an access terminal, a terminal, a mobile station, a subscriber unit, a station, etc. A UE may be a cellular phone, a personal digital assistant (PDA), a wireless modem, a wireless communication device, a handheld device, a laptop computer, a cordless phone, a wireless local loop (WLL) station, a tablet, a smart phone, a netbook, a smartbook, an ultrabook, etc. In aspects, the UE may include an MTC device or a wearable device. In aspects, the UE may be a single receive UE or a UE with a single receiver. In FIG. 1, a solid line with double arrows indicates desired transmissions between a UE and a serving eNB, which is an eNB designated to serve the UE on the downlink and/or uplink. A dashed line with double arrows indicates potentially interfering transmissions between a UE and an eNB.

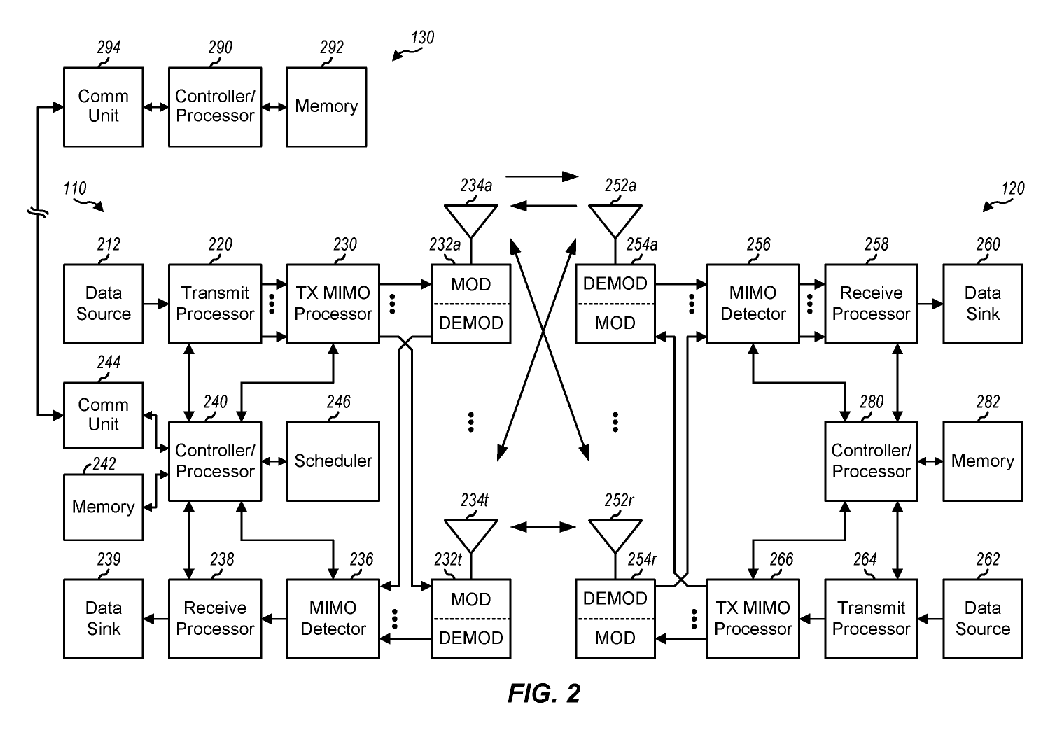

FIG. 2 shows a block diagram of a base station/eNB 110 and UE 120, which may be one of the base stations/eNBs and one of the UEs in FIG. 1. Base station 110 may be equipped with T antennas 234a through 234t, and UE 120 may be equipped with R antennas 252a through 252r, where in general T≧1 and R≧1.

At base station 110, a transmit processor 220 may receive data from a data source 212 for one or more UEs, select one or more modulation and coding schemes (MCS) for each UE based on CQIs received from the UE, process (e.g., encode and modulate) the data for each UE based on the MCS(s) selected for the UE, and provide data symbols for all UEs. Transmit processor 220 may also process system information (e.g., for SRPI, etc.) and control information (e.g., CQI requests, grants, upper layer signaling, etc.) and provide overhead symbols and control symbols. Processor 220 may also generate reference symbols for reference signals (e.g., the CRS) and synchronization signals (e.g., the PSS and SSS). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM, etc.) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively.

At UE 120, antennas 252a through 252r may receive the downlink signals from base station 110 and/or other base stations and may provide received signals to demodulators (DEMODs) 254a through 254r, respectively. Each demodulator 254 may condition (e.g., filter, amplify, downconvert, and digitize) its received signal to obtain input samples. Each demodulator 254 may further process the input samples (e.g., for OFDM, etc.) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 120 to a data sink 260, and provide decoded control information and system information to a controller/processor 280. A channel processor may determine RSRP, RSSI, RSRQ, CQI, etc. In aspects, the channel processor may be included in the receive processor 258 and/or controller/processor 280.

On the uplink, at UE 120, a transmit processor 264 may receive and process data from a data source 262 and control information (e.g., for reports comprising RSRP, RSSI, RSRQ, CQI, etc.) from controller/processor 280. Transmit processor 264 may also generate reference symbols for one or more reference signals. The symbols from transmit processor 264 may be precoded by a TX MIMO processor 266 if applicable, further processed by modulators 254a through 254r (e.g., for SC-FDM, OFDM, etc.), and transmitted to base station 110. At base station 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. Base station 110 may include communication unit 244 and communicate to network controller 130 via communication unit 244. Network controller 130 may include communication unit 294, controller/processor 290, and memory 292.

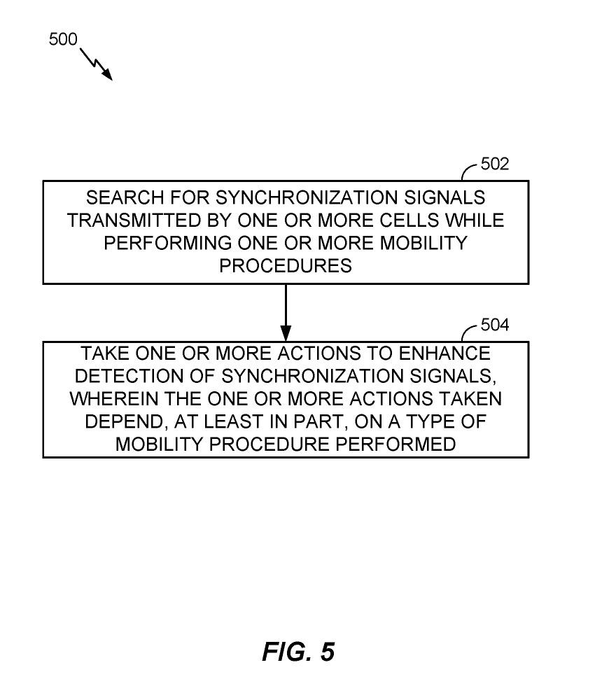

Controllers/processor 280 may direct the operation at UE 120. For example, controller/processor 280 and/or other processors, components, and/or modules at UE 120, may perform or direct operations 500 shown in FIG. 5. Memories 242 and 282 may store data and program codes for UE 120. In some aspects, one or more of the components shown in FIG. 2 may be employed to perform example processes 500 and/or other processes for the techniques described herein.

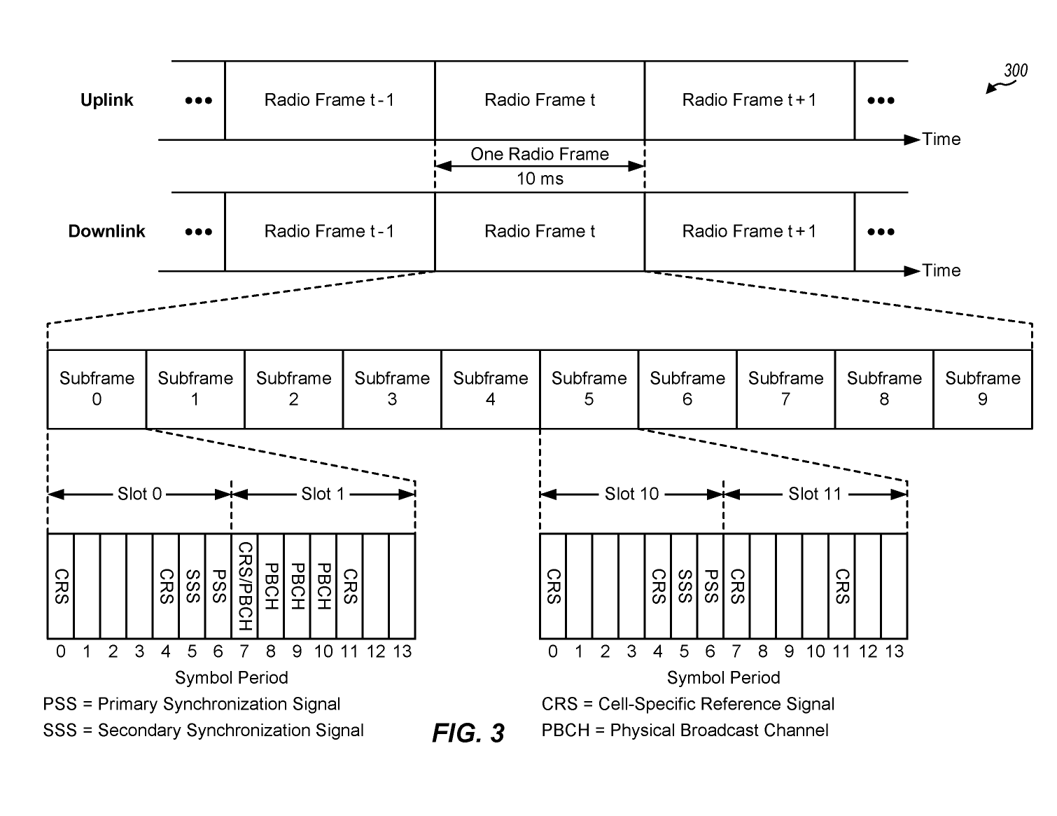

FIG. 3 shows an exemplary frame structure 300 for FDD in LTE. The transmission timeline for each of the downlink and uplink may be partitioned into units of radio frames. Each radio frame may have a predetermined duration (e.g., 10 milliseconds (ms)) and may be partitioned into 10 subframes with indices of 0 through 9. Each subframe may include two slots. Each radio frame may thus include 20 slots with indices of 0 through 19. Each slot may include L symbol periods, e.g., seven symbol periods for a normal cyclic prefix (as shown in FIG. 3) or six symbol periods for an extended cyclic prefix. The 2L symbol periods in each subframe may be assigned indices of 0 through 2L-1.

In LTE, an eNB may transmit a primary synchronization signal (PSS) and a secondary synchronization signal (SSS) on the downlink in the center of the system bandwidth for each cell supported by the eNB. The PSS and SSS may be transmitted in symbol periods 6 and 5, respectively, in subframes 0 and 5 of each radio frame with the normal cyclic prefix, as shown in FIG. 3. The PSS and SSS may be used by UEs for cell search and acquisition. The eNB may transmit a cell-specific reference signal (CRS) across the system bandwidth for each cell supported by the eNB. The CRS may be transmitted in certain symbol periods of each subframe and may be used by the UEs to perform channel estimation, channel quality measurement, and/or other functions. The eNB may also transmit a physical broadcast channel (PBCH) in symbol periods 0 to 3 in slot 1 of certain radio frames. The PBCH may carry some system information. The eNB may transmit other system information such as system information blocks (SIBs) on a physical downlink shared channel (PDSCH) in certain subframes. The eNB may transmit control information/data on a physical downlink control channel (PDCCH) in the first B symbol periods of a subframe, where B may be configurable for each subframe. The eNB may transmit traffic data and/or other data on the PDSCH in the remaining symbol periods of each subframe. In aspects, one or more of the above-described signals and/or channels may be transmitted in a different time and/or frequency resource.

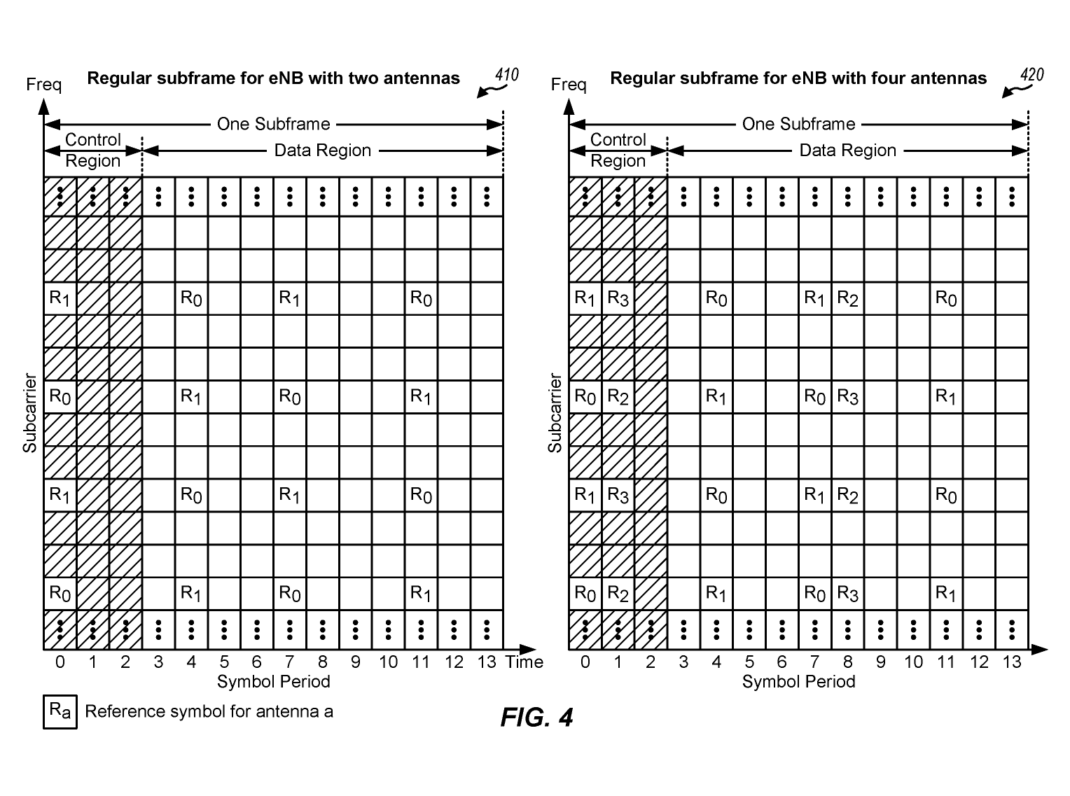

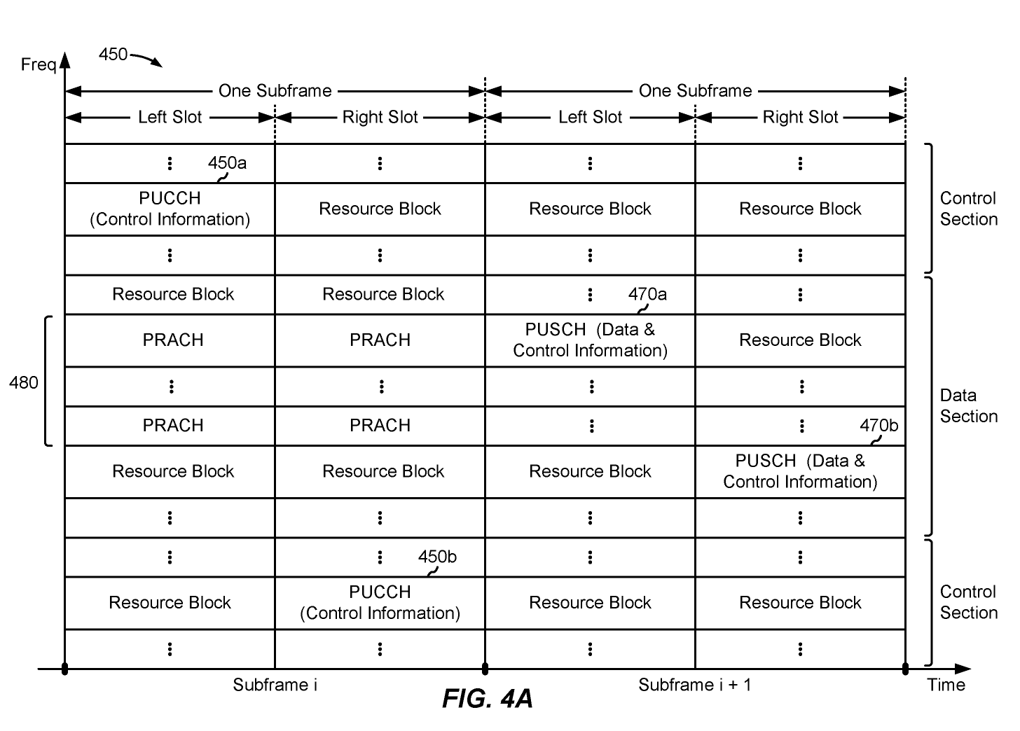

FIG. 4 shows two exemplary subframe formats 410 and 420 with the normal cyclic prefix. The available time frequency resources may be partitioned into resource blocks. Each resource block may cover 12 subcarriers in one slot and may include a number of resource elements. Each resource element may cover one subcarrier in one symbol period and may be used to send one modulation symbol, which may be a real or complex value.

Subframe format 410 may be used for two antennas. A CRS may be transmitted from antennas 0 and 1 in symbol periods 0, 4, 7 and 11. A reference signal is a signal that is known a priori by a transmitter and a receiver and may also be referred to as pilot. A CRS is a reference signal that is specific for a cell, e.g., generated based on a cell identity (ID). In FIG. 4, for a given resource element with label Ra, a modulation symbol may be transmitted on that resource element from antenna a, and no modulation symbols may be transmitted on that resource element from other antennas. Subframe format 420 may be used with four antennas. A CRS may be transmitted from antennas 0 and 1 in symbol periods 0, 4, 7 and 11 and from antennas 2 and 3 in symbol periods 1 and 8. For both subframe formats 410 and 420, a CRS may be transmitted on evenly spaced subcarriers, which may be determined based on cell ID. CRSs may be transmitted on the same or different subcarriers, depending on their cell IDs. For both subframe formats 410 and 420, resource elements not used for the CRS may be used to transmit data (e.g., traffic data, control data, and/or other data).

The PSS, SSS, CRS and PBCH in LTE are described in 3GPP TS 36.211, entitled “Evolved Universal Terrestrial Radio Access (E-UTRA); Physical Channels and Modulation,” which is publicly available.

An interlace structure may be used for each of the downlink and uplink for FDD in LTE. For example, Q interlaces with indices of 0 through Q−1 may be defined, where Q may be equal to 4, 6, 8, 10, or some other value. Each interlace may include subframes that are spaced apart by Q frames. In particular, interlace q may include subframes q, q+Q , q+2Q, etc., where q∈{0, . . ., Q−1}.

The wireless network may support hybrid automatic retransmission request (HARQ) for data transmission on the downlink and uplink. For HARQ, a transmitter (e.g., an eNB) may send one or more transmissions of a packet until the packet is decoded correctly by a receiver (e.g., a UE) or some other termination condition is encountered. For synchronous HARQ, all transmissions of the packet may be sent in subframes of a single interlace. For asynchronous HARQ, each transmission of the packet may be sent in any subframe.

A UE may be located within the coverage of multiple eNBs. One of these eNBs may be selected to serve the UE. The serving eNB may be selected based on various criteria such as received signal strength, received signal quality, pathloss, etc. Received signal quality may be quantified by a signal-to-noise-and-interference ratio (SINR), signal-to-noise ratio (SNR), a reference signal received quality (RSRQ), and/or some other metric. The UE may operate in a dominant interference scenario in which the UE may observe high interference from one or more interfering eNBs.

FIG. 4A is a diagram illustrating an example 450 of an uplink (UL) frame structure in LTE. The available resource blocks for the UL may be partitioned into a data section and a control section. The control section may be formed at the two edges of the system bandwidth and may have a configurable size. The resource blocks in the control section may be assigned to UEs for transmission of control information. The data section may include all resource blocks not included in the control section. The UL frame structure results in the data section including contiguous subcarriers, which may allow a single UE to be assigned all of the contiguous subcarriers in the data section.

A UE may be assigned resource blocks 450a, 450b in the control section to transmit control information to an eNB. The UE may also be assigned resource blocks 470a, 470b in the data section to transmit data to the eNB. The UE may transmit control information in a physical UL control channel (PUCCH) on the assigned resource blocks in the control section. The UE may transmit only data or both data and control information in a physical UL shared channel (PUSCH) on the assigned resource blocks in the data section. A UL transmission may span both slots of a subframe and may hop across frequencies.

A set of resource blocks may be used to perform initial system access and achieve UL synchronization in a physical random access channel (PRACH) 480, for example. However, additional and/or different set may be employed. The PRACH 480 carries a random sequence and cannot carry any UL data/signaling. Each random access preamble occupies a bandwidth corresponding to six consecutive resource blocks. The starting frequency is specified by the network. That is, the transmission of the random access preamble is restricted to certain time and frequency resources. There is no frequency hopping for the PRACH. The PRACH attempt is carried in a single subframe (e.g., of 1 ms) or in a sequence of few contiguous subframes and a UE can make only a single PRACH attempt per frame (e.g., of 10 ms). In aspects, one or more of the above-described signals and/or channels may be transmitted in additional and/or different time and/or frequency resources.

As indicated above, FIG. 4 is provided as an example. Other examples are possible and may differ from what was described above in connection with FIG. 4.

### Single Receive Long Term Evolution Mobility Enhancements

Since machine type communications (MTC) devices (e.g., MTC UEs) and wearables (e.g., wireless devices that may be worn, for example, by the user) transmit infrequently, UE-Category 1 (CAT1) and single receiver may be a common choice for MTC devices and/or wearables. A single receiver (e.g., a single Rx chain) may be advantageous for these types of devices as power consumption is low for single Rx. However, these types of devices may suffer from significant performance loss due to the lack of spatial diversity associated with single Rx. Accordingly, aspects of the present disclosure provide techniques for enhancing mobility performance such as initial acquisition, neighbour cell search, and/or neighbour cell measurements for single Rx LTE devices, such as those described above.

FIG. 5 illustrates example operations 500 for enhancing mobility of single receive (RX) devices. According to certain aspects, operations 500 may be performed, for example, by a UE having a single receive antenna (e.g., UE 120), to enhance mobility of the UE during one or more mobility procedures, (e.g., an initial acquisition procedure, a neighbour cell search procedure, and/or a neighbour cell measurement procedure).

Operations 500 begin at 502 by the UE searching for synchronization signals transmitted by one or more cells while performing one or more mobility procedures. At 504, the UE takes one or more actions to enhance detection of synchronization signals, wherein the one or more actions taken depend, at least in part, on a type of mobility procedure performed

As noted above, the one or more mobility procedures may include one or more of an initial acquisition procedure, a neighbour cell search procedure, or a neighbour cell measurement procedure. Techniques for enhancing mobility of single receive devices with respect to these mobility procedures will be described in greater detail below.

### Example Initial Acquisition Enhancements

According to certain aspects, being that single Rx LTE devices may not support spatial diversity, increasing the number of half frames (HF) or time resources over which a UE monitors for primary synchronization signals (PSSs)/secondary synchronization signals (SSSs) used for initial acquisition may replace Rx spatial diversity loss with time diversity. For example, in some cases, four HF combining may be used for initial acquisition with PSSs/SSSs occurring every half frame (e.g., every 5 subframes). However, increasing the number of HFs, for example, to eight HFs may allow the UE to better receive PSS and/or SSS and perform initial acquisition. Thus, in one example, taking one or more actions may involve a single RX UE selecting a number of HFs over which the UE monitors for PSSs/SSSs (e.g., for such better receipt and performance). For example, in order to improve enhancement of PSS/SSS detection, the UE may select a number of HFs (e.g., 8) and may combine PSSs/SSSs received over the selected number of HFs.

According to certain aspects, in some cases, the UE may end the initial acquisition procedure early (e.g., before all of the selected number of HFs have occurred). For example, the UE may end the initial acquisition procedure early if it determines that a signal to noise ratio (SNR) for the combined PSSs/SSSs is above a threshold for at least one HF of the selected number of HFs. For example, if the UE reliably detects that the SNR for the combined PSSs/SSSs is above a threshold for a certain number of HFs, the UE may decide to end the initial cell acquisition and search procedure early and run PBCH for the detected cells in order to save power resources (e.g., by not having to combine PSSs/SSSs over a remaining number of HFs).

Additionally, PSS and/or SSS thresholds may be fine-tuned for single Rx devices. For example, currently, PSS and SSS thresholds were selected to keep a target false alarm rate (Pfa) of one percent. Increasing the Pfa, however, may increase the probability of detection (Pd) which allows the UE to detect eNBs more reliably. According to certain aspects, for single Rx, different Pfa targets may be used for different acquisition modes. For example, for a list frequency search (LFS) mode, in which a frequency scan may be performed using prior successful acquisition information stored at the mobile device (i.e., UE), a high Pfa such as 10% may be used to improve detection while only marginally increasing the acquisition time. For a full frequency search (FFS), in which a frequency scan may be performed without any prior acquisition information at the mobile device, a lower Pfa such as 1% may be used to control how much time is spent scanning when there may be no or relatively few synchronization signals to detect (an “empty channel scan time”). Accordingly, taking one or more actions may comprise using (e.g., during a searching mobility procedure) a first set of thresholds for detecting PSSs and SSSs based on the UE performing an LFS and/or using a second set of thresholds for detecting PSSs and SSSs based on the UE performing an FFS.

Additionally or alternatively, diagonal loading may be used by a single Rx device to improve initial acquisition. For example, currently, PSS diagonal loading for receive chain Rx0 and receive chain Rx1 (e.g., of a non-single Rx device) are computed separately based on a maximum energy. According to certain aspects, for single Rx, to avoid any numerical issue due to the Rx1, time domain (TD) samples which may be same as Rx0 TD samples or all zeros if Rx1 TD samples are nulled, and Rx1 diagonal loading parameters may be set to that of Rx0 diagonal loading parameters. Thus, according to certain aspects, taking one or more actions by a single Rx device may comprise setting/employing same diagonal loading parameters (e.g., time diverse values) to represent values for different receive antennas (e.g., receive antennas Rx0 and Rx1 of a non-single Rx device if such device was performing the operation).

As noted above, increasing the number of HFs may improve PSS detection. However, increasing the number of HFs may not be sufficient to improve the probability of detection, Pd, for SSS as SSS does not enjoy eight HF combining like the PSS. Instead, according to certain aspects, the probability of detection, Pd, may be increased by lowering an SSS threshold. However, lowering the SSS threshold may increase the false alarm rate, Pfa.

Currently, any SSS peaks above a threshold may be added to a final candidate cell list after every HF. For example, even if the peaks satisfy this threshold only once, they will be added to the final candidate cell list. This means that spurious peaks will be added to the final list, as most spurious peaks can satisfy the threshold only once, which may increase the false detection rate.

According to certain aspects, however, to reduce the false detection rate, Pfa, only SSS peaks that exceed a threshold value for more than once (e.g., twice) may be added to the final candidate cell list (e.g., over more than one HF (e.g., two or more HFs)). Accordingly, for example, taking one or more actions (e.g., during a search mobility procedure) may comprise selecting SSS candidates only if corresponding correlation peaks exceed a threshold value for more than one of the number of HFs. According to certain aspects, using this rule, probability of detection, Pd, may be improved by taking advantage of the lower Pfa by lowering the SSS threshold.

According to certain aspects, given that this rule may be implemented, the Pd may decrease when the SSS threshold is decreased since numerous spurious cells may crowd out legitimate cells in the limited list of 8 cells. According to certain aspects, to address the issue of spurious cells crowding out legitimate cells, the candidate cell list size may be increased to 128 cells. According to certain aspects, the list may include only cells that are seen more than twice (per the above rule). In aspects, the cells in the list may be sorted based on their maximum SSS signal to noise ratio (SNR).

### Example Neighbour Cell Search Enhancements

According to certain aspects, neighbor cell search for single Rx devices may also be improved by increasing a number of HFs or time resources (e.g., over which a UE is to perform a neighbour cell search). For example, currently, for a connected mode without gaps, 1 HF and 2HF are used alternatively in a neighbor cell search mobility procedure. However, it may be beneficial to use 2 HFs all the time as there may not be any additional power consumption associated with this. However, in the “gap” case, 1 HF search may still be used due to software (e.g., FW/ML) timeline constraints.

According to certain aspects, for connected discontinuous reception (CDRX) mode without gaps, 1HF is used for a neighbor cell search. However, to limit power impact, in aspects, 2HFs may be used for a neighbour cell search (e.g., only) for Light Panic and Panic states.

According to certain aspects, for an idle discontinuous reception (IDRX)-online mode, 1HF is used for a neighbor cell. However, in certain aspects, 2HFs may be used for a neighbour cell search for a Light Panic state and 4HFs may be used for a neighbour cell search for a Panic state.

Thus, according to certain aspects, taking one or more actions during, for example, a neighbor cell search mobility procedure, may comprise selecting a number of HFs based, at least in part, on an operating mode of the UE (e.g., connected mode without gaps, CDRX without gaps, IDRX-online, etc.). Additionally, according to certain aspects, when a UE is in a DRX mode, the number of HFs may be selected based further, at least in part, on a panic state of the UE, wherein the panic state may be based on a signal quality metric (e.g., reference signal receive strength, reference signal receive quality, or signal to noise ratio) and may determine how often the neighbor cell search procedure is performed.

According to certain aspects, fine tuning of PSS and/or SSS thresholds, similar to initial acquisition, described above, may also be beneficial and employed for neighbor cell searches. Additionally or alternatively, diagonal loading may be used by a single Rx device to improve neighbor cell searches similar to that described above for initial acquisition. For example, for diagonal loading, RX1 diagonal loading may need to be set to that of RX0 diagonal loading for PSS.

According to certain aspects, due to a longer coherence time, enough gain to support single RX device may not be expected only with increasing the number of HFs in a low Doppler environment. Thus, according to certain aspects, based on Doppler or rate of changes of signal quality measurements, for example, reference signal receive power (RSRP)/reference signal receive quality (RSRQ)/SNR, a UE may increase periodicity rather than the number of HFs (e.g., by sacrificing power).

In aspects, for neighbor cell searches, PSS combining across HF may not be performed. Consequently, increasing the number of HFs may only help with “repetition diversity” as opposed to “combining diversity”. Accordingly, doubling the periodicity of 1HF search may show comparable performance as compared to 2HF neighbor cell search. According to certain aspects, to improve neighbor cell search performance, either periodicity or the number of HFs may be increased. To improve power consumption, increasing the number of HFs may be employed (e.g., IDRX-online mode to minimize warm up overhead, which may be incurred if periodicity is increased instead). In aspects, it may be possible to use 2HFs or 4HFs in IDRX mode, which may have no gap induced timeline.

Thus, according to certain aspects, taking one or more actions may comprise selecting a periodicity of one or more portions of HFs (e.g., periodicity in units of one or more HFs) in which to perform the searching for a neighbor cell. In some cases, the periodicity may be increased with less number of HFs for the UEs which are at low Doppler or the search periodicity may be decreased with more HFs for the UEs which are at high Doppler.

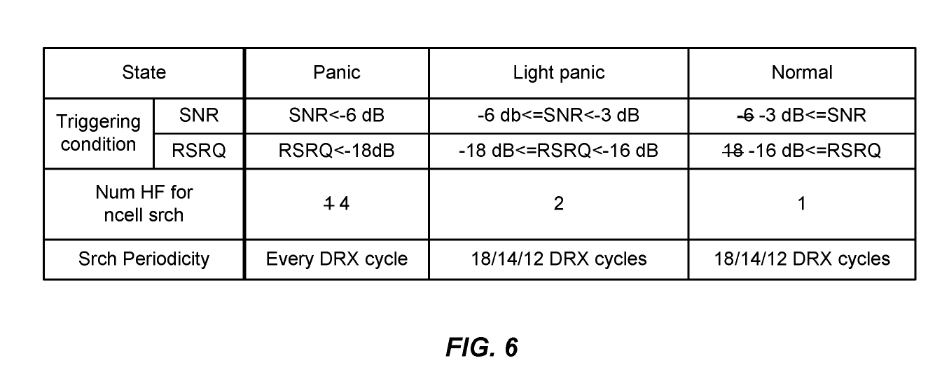

Additionally, according to certain aspects, a “Light Panic state” may be added for IDRX-online without a periodicity change but with an increase of the number of HFs for a neighbour cell search (e.g., to 2), for example, as seen in FIG. 6.

### Example Neighbour Cell Measurement Enhancements

Compared to a 2Rx device where the maximum RSRP across RX0 and RX1 may be chosen, a 1Rx device may underestimate RSRP (e.g., significantly) due to the loss of spatial diversity, which may be exacerbated in narrow band measurements. In aspects, to avoid RSRP underestimation for a 1Rx device, the maximum RSRP across time may be chosen via multiple measurements, thus replacing the lost spatial diversity with temporal diversity. To wit, in order to replace lost spatial diversity associated with single a RX device, the UE may determine a maximum RSRP among a plurality of RSRP measurements during various time periods/windows. Thus, taking one or more actions may comprise selecting, a maximum reference signal receive power (RSRP) across time via multiple measurements during a time window. Additionally, in some cases, when the UE is in a discontinuous reception (DRX) mode, a length of the time window during which the measurement(s) are made may be selected based, at least in part, on a panic state of the UE, wherein the panic state determines how often the measurement is performed and the panic state is based on a signal quality metric.

According to certain aspects, the following algorithm may be used to improve RSRP estimation. In aspects, the following algorithm may employ a minimum of 2 subframe measurements per cell, but up to 8 subframe measurements per cell may be employed. For example, according to certain aspects, to improve RSRP estimation, the UE (e.g., software of the UE) may split a number of subframes into two groups. Subsequently, an Infinite Impulse Response (IIR) filter may filter channel energy responses within each group separately. According to certain aspects, no filtering may be performed for the 2 subframe measurement case. After filtering, two RSRPs may be computed, one for each of the two groups of subframes. The computed RSRPs may be reported back as RX0 and RX1 RSRPs using an existing API. According to certain aspects, the ML may then choose the maximum RSRP across RX0 and RX1, requiring no API or ML change. Thus, according to certain aspects, taking one or more actions may comprise measuring RSRP for a first group of subframes, measuring RSRP for a second group of subframes, reporting the RSRP for the first group of subframes as, or to represent an, RSRP for a first antenna (e.g., Rx0), and reporting the RSRP for the second group of subframes as, or to represent an, RSRP for a second antenna (e.g., Rx1). In aspects, such reported RSRPs may be employed (e.g., as parameters) by a 2Rx algorithm on a 1Rx device.

The above proposal/algorithm, however, may need at least 2 subframe measurements per cell to ensure correct RSRP estimation, which is not guaranteed in all cases. Thus, aspects of the present disclosure provide techniques for ensuring 2 subframe measurements per cell for improving RSRP estimation (potentially at the expense of power). For example, in connected and IDRX-Online modes, ML and FW may already schedule at least 2 subframe measurements per cell regardless of the number of cells.

Currently, in CDRX, with a “short” ON duration (e.g., 9 ms), 1 subframe measurements/cell measurement may be performed if the number of cells is greater than 5. For example, the ML may configure “short” ON duration if the actual ON duration is less than the minimum time needed for measurement. If, however, the actual ON duration is not less than the minimum time needed for measurement, then the ML may configure a “long” ON duration equal to either the time to the next gap or the actual ON duration, whichever is less. According to certain aspects, if the “long” ON duration is configured, there will be 2 subframe measurements per cell regardless of the number of cells.

According to certain aspects, the above-described RSRP measurement may be improved. To wit, accuracy may be improved in certain panic states at the expense of power. For example, for CDRX, if the actual on duration is less than the minimum time needed for measurement, the ON duration may be increased to either the time to the next gap or the time to the next software report period (SWRP), whichever is less. To reduce and/or minimize power impact, the increase of the ON duration may only be applied to “Light Panic” and “Panic” states with a gap, and additionally or alternatively, to a new “Lighter Panic” state for modes with and without gaps.

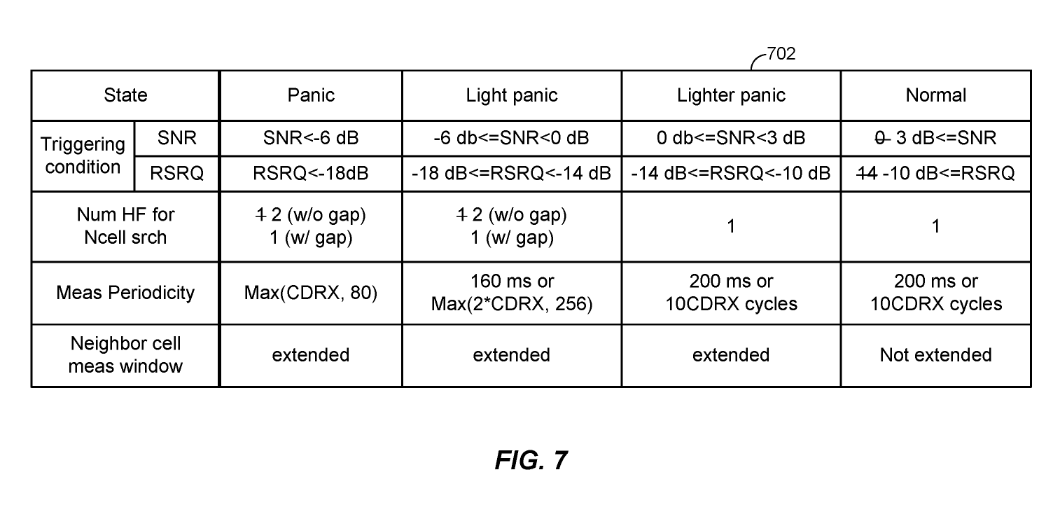

Additionally, according to certain aspects, a new panic state (e.g., “Lighter Panic” state 702), for example as illustrated in FIG. 7, may be used in CDRX to improve neighbor cell measurement quality. According to certain aspects, the “Lighter Panic” state may increase measurement quality between 0 and 3 dB SNR or 0 dB<=SNR<3 dB by increasing the measurement window in order to track potential fast-rising neighbor cells. Additionally, for the “Lighter Panic” state, the number of HFs may be 1 and the periodicity may be 200 ms. Further, according to certain aspects, based on Doppler or the rate of changes of RSRP, RSRQ, and/or SNR, a UE may increase the measurement periodicity.

According to certain aspects, the techniques provided herein may enhance mobility performance of devices having one a single receive chain (e.g., having only a single receive antenna). According to certain aspects, any combination of the above techniques may be used.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

In some cases, rather than actually transmitting a frame, a device may have an interface to output a frame for transmission. For example, a processor may output a frame, via a bus interface, to an RF front end for transmission. Similarly, rather than actually receiving a frame, a device may have an interface to obtain a frame received from another device. For example, a processor may obtain (or receive) a frame, via a bus interface, from an RF front end for transmission.

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

For example, means for outputting and means for transmitting may be the transmit processor 220, modulator 232, and/or antenna(s) 234 of eNB 110 illustrated in FIG. 2 or the transmit processor 264, modulator 254, and/or antenna(s) 252 of UE 120 illustrated in FIG. 2. Means for outputting and means for receiving may be the receive processor 238, demodulator 232, and/or antenna(s) 234 of eNB 110 illustrated in FIG. 2 or the receive processor 258, demodulator 254, and/or antenna(s) 252 of UE 120 illustrated in FIG. 2.

Means for searching, means for taking one or more actions, means for determining, means for measuring, and/or means for reporting, may comprise a processing system, which may include one or more processors, such as the controller/processor 240, communication unit 244 of the eNB 110 or the controller/processor 280 of the UE 120 illustrated in FIG. 2.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a UE 120 (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

1. A method for wireless communications by a user equipment (UE) having a single receive antenna, comprising:
searching for synchronization signals transmitted by one or more cells while performing one or more mobility procedures; and
taking one or more actions to enhance detection of synchronization signals and measurement of neighbor cells, wherein the one or more actions taken depend at least in part on a type of mobility procedure performed.

2. The method of claim 1, wherein taking the one or more actions comprises:
selecting a number of half frames (HFs) over which the UE monitors for primary synchronization signals (PSSs).

3. The method of claim 2, wherein, for an initial acquisition procedure, the searching comprises combining primary synchronization signals (PSSs) over the selected number of HFs.

4. The method of claim 3, further comprising:
determining that a signal to noise ratio (SNR) for the combined PSSs is above a threshold for at least one HF of the selected number of HFs; and
wherein taking one or more actions comprises stopping the initial cell search before all HFs of the selected number of HFs have occurred, based on the determination.

5. The method of claim 3, wherein:
a first set of thresholds is used for detecting PSS and secondary synchronization signals (SSS) for initial acquisition based on a list frequency search (LFS); and
a second set of thresholds is used for detecting PSS and SSS for initial acquisition based on a full frequency search (FFS).

6. The method of claim 5, wherein the searching comprises selecting secondary synchronization signal (SSS) candidates only if corresponding correlation peaks exceed a threshold value for more than one of the selected number of HFs.

7. The method of claim 2, wherein, for a neighbor search procedure, the selected number of HFs is selected based, at least in part, on an operating mode of the UE.

8. The method of claim 7, wherein, when the UE is in a discontinuous reception (DRX) mode, the selected number of HFs is further selected based, at least in part, on a panic state of the UE, wherein the panic state determines how often the searching is performed and the panic state is based on a signal quality metric.

9. The method of claim 1, wherein, for measurement of neighbor cells, taking the one or more actions comprises selecting a maximum reference signal receive power (RSRP) across time via multiple measurements during a time window.

10. The method of claim 9, wherein taking the one or more actions comprises:
measuring reference signal receive power (RSRP) for a first group of subframes;
measuring RSRP for a second group of subframes;
reporting the RSRP for the first group of subframes as RSRP for a first antenna; and
reporting the RSRP for the second group of subframes as RSRP for a second antenna.

11. The method of claim 9, wherein, when the UE is in a discontinuous reception (DRX) mode, a length of the time window during which the measurements are made is selected based, at least in part, on a panic state of the UE, wherein the panic state determines how often the measurement is performed and the panic state is based on a signal quality metric.

12. The method of claim 1, wherein taking one or more actions comprises selecting a periodicity of one or more portions of HFs in which to perform the searching.

13. The method of claim 12, wherein:
the periodicity is increased with less number of HFs for UEs which are at low Doppler; or
the periodicity is decreased with more HFs for UEs which are at high Doppler.

14. The method of claim 1, wherein taking the one or more actions comprises employing time diverse values to represent values for different antennas.

15. An apparatus for wireless communications by a user equipment (UE) having a single receive antenna, comprising:
means for searching for synchronization signals transmitted by one or more cells while performing one or more mobility procedures; and
means for taking one or more actions to enhance detection of synchronization signals and measurement of neighbor cells, wherein actions taken by the means for taking one or more actions depend at least in part on a type of mobility procedure performed.

16. The apparatus of claim 15, wherein the means for taking the one or more actions are configured to select a number of half frames (HFs) over which the UE monitors for primary synchronization signals (PSSs).

17. The apparatus of claim 16, wherein, for an initial acquisition procedure, the means for searching are configured to combine primary synchronization signals (PSSs) over the selected number of HFs.

18. The apparatus of claim 17, further comprising:
means for determining that a signal to noise ratio (SNR) for the combined PSSs is above a threshold for at least one HF of the selected number of HFs; and
wherein the means for taking one or more actions are further configured to stop the initial cell search before all HFs of the selected number of HFs have occurred, based on a determination that the SNR for the combined PSSs is above the threshold for the at least one HF of the selected number of HFs.

19. The apparatus of claim 17, wherein:
a first set of thresholds is used for detecting PSS and secondary synchronization signals (SSS) for initial acquisition based on a list frequency search (LFS); and
a second set of thresholds is used for detecting PSS and SSS for initial acquisition based on a full frequency search (FFS).

20. The apparatus of claim 19, wherein the means for searching are configured to select secondary synchronization signal (SSS) candidates only if corresponding correlation peaks exceed a threshold value for more than one of the selected number of HFs.

21. The apparatus of claim 16, wherein, for a neighbor search procedure, the means for taking one or more actions are further configured to select the number of HFs based, at least in part, on an operating mode of the UE.

22. The apparatus of claim 21, wherein, when the UE is in a discontinuous reception (DRX) mode, the means for taking one or more actions are further configured to select the number of HFs is based further, at least in part, on a panic state of the UE, wherein the panic state determines how often the searching is performed and the panic state is based on a signal quality metric.

23. The apparatus of claim 15, wherein, for measurement of neighbor cells, the means for taking the one or more actions are configured to select a maximum reference signal receive power (RSRP) across time via multiple measurements during a time window.

24. The apparatus of claim 23, wherein the means for taking the one or more actions are further configured to:
measure reference signal receive power (RSRP) for a first group of subframes;
measure RSRP for a second group of subframes;
report the RSRP for the first group of subframes as RSRP for a first antenna; and
report the RSRP for the second group of subframes as RSRP for a second antenna.

25. The apparatus of claim 23, wherein, when the UE is in a discontinuous reception (DRX) mode, the means for taking one or more actions are further configured to select a length of the time window during which the measurements are made based, at least in part, on a panic state of the UE, wherein the panic state determines how often the measurement is performed and the panic state is based on a signal quality metric.

26. The apparatus of claim 15, wherein the means for taking one or more actions are configured to select a periodicity of one or more portions of HFs in which to perform the searching.

27. The apparatus of claim 26, wherein:
the periodicity is increased with less number of HFs for UEs which are at low Doppler; or
the periodicity is decreased with more HFs for UEs which are at high Doppler.

28. The apparatus of claim 15, wherein the means for taking the one or more actions are configured to employ time diverse values to represent values for different antennas.

29. An apparatus for wireless communications by a user equipment (UE) having a single receive antenna, comprising:
at least one processor configured to:
search for synchronization signals transmitted by one or more cells while performing one or more mobility procedures; and
take one or more actions to enhance detection of synchronization signals and measurement of neighbor cells, wherein the one or more actions taken depend at least in part on a type of mobility procedure performed; and
a memory coupled with the at least one processor.

30. A non-transitory computer-readable medium comprising one or more instructions for:
searching for synchronization signals transmitted by one or more cells while performing one or more mobility procedures; and
taking one or more actions to enhance detection of synchronization signals and measurement of neighbor cells, wherein the one or more actions taken depend at least in part on a type of mobility procedure performed.
